(19) United States
(12) Patent Application Publication
(10) Pub. No.: US 2024/0193767 A1
(43) Pub. Date: Jun. 13, 2024

(54) METHOD FOR OBTAINING ARTERIAL INPUT FUNCTION FROM REGION OF INTEREST

(71) Applicant: Jubilant Draximage Inc., Montreal (CA)

(72) Inventors: Eric James Moulton, Montreal (CA); Robert A. DeKemp, Ottawa (CA); Indranil Nandi, Yardley, PA (US); Chad Roger Ronald Nicholas Hunter, Ottawa (CA)

(21) Appl. No.: 18/412,857

(22) Filed: Jan. 15, 2024

Related U.S. Application Data
(63) Continuation-in-part of application No. 18/242,131, filed on Sep. 5, 2023.
(60) Provisional application No. 63/499,399, filed on May 1, 2023.
(60) Provisional application No. 63/374,732, filed on Sep. 6, 2022.

(51) Int. Cl. G06T 7/00; G06T 7/11

(52) U.S. Cl. CPC G06T 7/0012; G06T 7/11; G06T 2207/20084; G06T 2207/30101

(57) ABSTRACT

The present invention discloses methods for automatically computing an arterial input function from one or more regions of interest, the method comprising: a. obtaining a plurality of dynamic image data sets comprising volumetric image data from the regions of interest over multiple scanning intervals; b. utilizing an artificial neural network to segment the plurality of dynamic image data sets displaying one or more arterial input function(s) (AIF) in the region(s) of interest; c. automatically estimating, using artificial intelligence, an arterial input function based on plurality of dynamic image data sets combined with one or more time activity curves (TAC) in the region(s) of interest in target organ(s); and d. computing a pre-trained predictive pharmacokinetic AI model arterial input function using time activity curve input associated with region(s) of interest of target organ(s).

### CROSS-REFERENCE TO RELATED APPLICATIONS

The application is a continuation-in-part of application Ser. No. 18/242,131, filed on Sep. 5, 2023.

### BACKGROUND OF THE INVENTION

Nuclear medicine employs radioactive material for therapy and diagnostic imaging. Different types of diagnostic imaging are available that utilize doses of radiopharmaceuticals. The desired doses of radiopharmaceuticals can be injected or infused into a patient prior to or during the diagnostic imaging procedure, wherein the radiopharmaceuticals can be absorbed by the cells or adhered to the cells of a target organ of the patient and emit radiation. The scanner or detector of the diagnostic imaging process can then detect the emitted radiation in order to generate an image of an organ. For example, to image body tissue such as the heart muscle, a patient can be infused or injected with Rb-82 (i.e., Rubidium-82). The diagnostic imaging procedure can detect the radiation of Rb-82 and facilitate better images of myocardium to diagnose any clinical disease.

Radioisotopes play a pivotal role in diagnosis and mitigation of various disease conditions. For example, ⁶⁰Co in treatment of cancer, ¹³¹I in treatment of hyperthyroidism, ¹⁴C in breath tests, ^{99m}Tc and ⁸²Rb as tracers in myocardial perfusion imaging.

Further, Rubidium-82 is produced in-situ by radioactive decay of Strontium-82. Rubidium elution systems utilize doses of rubidium-82 generated by elution within a radioisotope generator, and infuse or inject the radioactive solution into a patient.

Previously, preclinical studies in dogs showed that myocardial uptake of Rb-82 radionuclide was directly related to myocardial blood flow (MBF). Dynamic cine myocardial perfusion imaging (MPI) with radioisotopes can produce accurate prediction of myocardial blood flow (MBF) and myocardial flow reserve (MFR) through pharmacokinetic modeling of various compartment models, such as the one tissue compartment model. Typically, MBF estimation begins with segmentation of the left ventricle (LV) myocardium followed by tracer kinetic modeling in a limited number of two-dimensional (2D) polar-map sectors or segments. However, two-dimensional (2D) polar-map segments have drawbacks. Few cardiac disorders related to flow in small regional flow defect can be visualized properly in a two-dimensional (2D) polar-map. Therefore, there is an alternate method of myocardial perfusion imaging by visualizing three-dimensional (3D) parametric maps of MBF. But, there are some disadvantages in practicing of visualizing three-dimensional (3D) parametric maps of MBF. Further, in identifying small regional flow defects are not always visible. Additionally, generating the three-dimensional (3D) parametric maps is time consuming and is less stable. These disadvantages discourage the healthcare providers to adopt the use of 3D parametric maps of MBF for estimating myocardial blood flow. Therefore, there is a need for an alternative approach to generate more stable three-dimensional (3D) parametric maps in lesser time to estimate not only the myocardial blood blow and flow reserve for cardiac PET but for any pharmacokinetic modeling for other organs, such as the brain, kidneys, lower extremities, etc.

Rb-82 PET imaging was performed using a single fixed dose for all patients, due in part to limitations of early-generation tracer delivery systems. This undesirable effect of old PET imaging systems can be mitigated to some extent by using the advanced and latest generation Rb-82 elution system. The present inventors observed that by using the 3D parametric imaging of myocardial perfusion with Rb-82 PET, and can accurately estimate and/or predict myocardial blood flow (MBF) and/or myocardial flow reserve (MFR).

Myocardial automated estimation generally includes image preprocessing, arterial input function (AIF) selection, deconvolution computation, parametric map generation, blood volume computation, and the like, wherein AIF participates in deconvolution operation. The radio tracer residual curve can be obtained by deconvolution operation of the time activity curve (TAC) and AIF, and the above-mentioned various hemodynamic parameters and parameter diagrams thereof can be obtained by further calculation of the TAC.

The AIF points typically select arterial voxels located on the left ventricle for myocardium and these curves typically have a peak height, small peak width, early peak time profile. At present, the AIF selection method mainly comprises the methods of manual selection by operator, technician and constructing a curve characteristic weighting model. However, the manual selection method has the disadvantages of long time consumption, low repeatability and reliance on operator experience; the method for constructing the curve characteristic weighting model needs to manually construct characteristics and design a complex mathematical model.

Further, for accurate pharmacokinetic modeling, for example with a one-tissue compartment model (1TCM), one relies on proper placement of a region of interest (ROI) for deriving an arterial input function (AIF). However, inter-operator variability is a major source of differences in kinetic modeling parameter estimates. Therefore, previous work has taken advantage of artificial intelligence (AI) mostly in a supervised fashion to automatically reproduce ROIs or AIFs from expert annotations. However, for certain applications, the optimal placement of the ROI is still a subject of research. In the case of myocardial blood flow (MBF) estimation, the ROI is typically placed in the left ventricle (LV) although previous research has suggested that other areas, such as the left atrium (LA), could yield more reproducible MBF measures. In the present invention, the inventors used a purely self-supervised approach with an AI algorithm that generates a ROI and thus, AIF optimized to minimize the fits of a specific pharmacokinetic model. Such a data-driven approach cannot only potentially improve estimates of kinetic modeling parameters by incorporating the appropriate physical equations into its training, such as those for MBF, but also validate existing methods of ROI placement.

### SUMMARY OF THE INVENTION

The present invention aims to provide an image processing method to assess quantitative myocardial blood flow (MBF) and/or myocardial flow reserve (MFR).

The present invention discloses methods for obtaining the arterial input function (AIF) by using a fully automated unsupervised trained neural network model, to improve accuracy and the robustness of calculation and analysis of 3D parametric map.

The object of the present invention is to provide an alternate method to use 3D voxel-wise parametric imaging data to estimate and/or predict quantitative myocardial blood flow (MBF) and/or myocardial flow reserve (MFR), which may better highlight small regional flow defects. More precisely, the inventors of the present invention estimate the myocardial blood flow (MBF) and/or myocardial flow reserve (MFR), wherein the image series fit to a one-tissue-compartment model yielding voxel-wise parametric maps comparing the projected data onto a two-dimensional (2D) polar map of the left ventricle (LV). The present invention, therefore, has an advantage of producing regional flow and reserve values, which may highlight better the small regional flow defects and are independent of LV polar-map segmentation.

The object of the present invention is to provide an image processing method to assess quantitative myocardial blood flow and/or myocardial flow reserve, wherein the image reconstruction algorithms are designed to improve the quality of images by using the AI algorithm to enhance the image reconstruction quality, which is intended to do the image processing faster and reduce the doses of nuclear medicine up to 10 times during the myocardial perfusion imaging (MPI).

The object of the present invention for AI models can generate blood flow parametric maps with high accuracy and in a timeframe acceptable for clinical use and thus may enable future clinical implementation.

The object of the present invention is to provide an image processing method to assess quantitative myocardial blood flow and/or myocardial flow reserve, wherein 3D parametric images of MBF generated by present invention also recommend the calcium scoring.

In an embodiment of the present invention, an image processing method to assess quantitative myocardial blood flow and myocardial flow reserve, comprises the steps of:
a. pre-processing of images comprises:
(i) reconstructing dynamic cine 3D tomographic myocardial perfusion imaging (MPI) data,
(ii) isolating value at voxel (i,j,k) for each time point t; where i is from 1 to N,
(iii) optionally, denoising to improve the quality of image,
(iv) extracting blood input function from a region of interest (ROI) of the left ventricle blood cavity or other arterial blood region of region of interest (ROI),
(v) estimating the distribution volume (DV), given by the ratio of uptake and washout rates (K₁/K₂) to stabilize and improve estimation of K₁ and total blood volume (TBV) and subsequent myocardial blood flow measures, and
(vi) data normalization by dividing by the maximum of the blood input function;
b. assessing the individual signals pre-processed in step (a) in order to generate K₁ and TBV parametric maps from the one tissue compartment model using an artificial neural network;
c. post-processing of K₁ and TBV parametric maps; and of rest and stress myocardial blood flow to estimate myocardial flow reserve (MFR) and/or coronary flow reserve (CFR).

An embodiment of the present invention includes the image processing method to assess quantitative myocardial blood flow and myocardial flow reserve, wherein the image reconstruction of arrays is a dynamic cine series comprising the 3D tomographic voxel (i,j,k) from PET reconstruction for the number of time steps, ti, where i is from 1 to N.

In another embodiment of the present invention, the image processing method is used to assess quantitative myocardial blood flow and myocardial flow reserve, wherein the input signal enters a multi-layer perceptron (MLP), an artificial neural network and/or convolutional neural network (CNN) and/or long short term memory (LSTM) network to simultaneously predict uptake rate (K₁), washout rate (K₂) and total blood volume (TBV).

In another embodiment of the present invention, the image processing method is used to assess quantitative myocardial blood flow and/or myocardial flow reserve, wherein the imaging agent or radionuclide is administered by automated generation and infusion system and/or intravenous administration of radiopharmaceuticals produced by fission, neutron activation, cyclotron, generator and/or combinations thereof.

In another embodiment of the present invention, an image processing method to assess quantitative myocardial blood flow and myocardial flow reserve, comprises the steps of:
a. pre-processing of images comprises:
(i) reconstructing dynamic cine 3D tomographic myocardial perfusion imaging (MPI) data,
(ii) isolating value at voxel (i,j,k) for each time point t; where i is from 1 to N,
(iii) optionally, denoising to improve the quality of image,
(iv) extracting blood input function from a region of interest (ROI) of the left ventricle blood cavity or other arterial blood region of interest (ROI),
(v) estimating the distribution volume (DV), given by the ratio of uptake and washout rates (K₁/K₂) to stabilize and improve estimation of K₁, K₂ and total blood volume (TBV) and subsequent myocardial blood flow measures, and
(vi) data normalization by dividing by the maximum of the blood input function,
b. applying the time series at voxel (i,j,k) and blood input function to artificial intelligence network simultaneously to predict uptake K₁, K₂ and TBV,
c. post-processing of K₁, K₂ and TBV parametric maps comprises:
(i) partial volume correction,
(ii) extraction fraction to estimate myocardial blood flow (MBF) at rest and stress; and
d. post-processing of rest and stress myocardial blood flow to estimate myocardial flow reserve (MFR) and/or coronary flow reserve (CFR);
wherein the artificial neural networks are selected from the group consisting of, multi-layer perceptron (MLP), artificial neural network (ANN), convolutional neural network (CNN), recurrent neural network (RNN), long short-term memory recurrent neural network (LSTM-RNN), gated recurrent unit (GRU) network, Generative adversarial networks (GANs), deep machine learning and/or combinations thereof.

Another embodiment of the present invention includes an image processing method to estimate the arterial input function, wherein the artificial neural network is trained to directly predict one or several pharmacokinetic parameters (e.g., K1, k2, etc.) from a set of ground truth labels.

In another embodiment of the present invention, an image processing method is used to estimate the arterial input function, wherein the artificial neural network is trained to directly predict one or several pharmacokinetic parameters (e.g., K1, k2, etc.) by incorporating the equations of the appropriate compartmental model in order to minimize the error between the theoretical time activity curve (TAC) from said compartment model to the observed TAC at a given voxel.

In another embodiment of the present invention, an image processing method is used to estimate the arterial input function, wherein the artificial neural network can also predict K1, k2, k3, k4 of the three-compartment model (two-tissue compartment model) or K1, k2, k3, k4, k5, k6 of the four-compartment model (three-tissue compartment model) and K1, k2′, k3′, k4 of the four compartment model where k2′=k2/(1+k5/k6) and k3′=k3/(1+k5/k6), as is typically used in brain compartmental modeling for brain receptor studies. All modifications of aforementioned models, where at least one of these parameters is fixed to equal 0 and is thus not predicted. All aforementioned parameters with delay (Δt) and dispersion factors. All aforementioned parameters with fractional blood pool terms (TBV) and spillover corrections from other blood pools (for example, the right ventricle VRV). These above mentioned models can also be used for calculation of other parametric map, where the present method of calculation of arterial input function by using unsupervised learning can be used.

### BRIEF DESCRIPTION OF DRAWINGS

Further features and advantages of the present invention will become apparent from the following detailed description, taken in combination with the appended drawings, in which:

FIG. 1 illustrates the flow diagram, wherein the model takes blood input function, and the time series at voxel for output K₁, K₂ and TBV (total blood volume).

FIG. 2 illustrates the flow diagram, wherein the model takes blood input function, the time series at voxel, and distribution volume (DV) for output K₁ and TBV (total blood volume).

FIG. 3 illustrates the flow diagram for model training.

FIGS. 4-19 illustrates the ground truth vs AI-generated parametric maps.

FIG. 20 illustrates a workflow for training the AI-AIF segmentation network.

FIG. 21 illustrates a workflow to use the trained AI-AIF segmentation network for quality assurance of the algorithm and for generating parametric maps used for image interpretation or outcome prediction.

FIG. 22 illustrates AI-derived ROIs superimposed on a representative patient's stress and rest ⁸²Rb exams wherein the ROI is automatically placed on a region spanning the left and right ventricle.

FIG. 23 illustrates agreement between K1 and TBV parametric maps of four test patients' stress images using reference nonlinear least squares (NLS) curve fitting vs. AI. For each panel: (left) NLS reference map, (middle) AI generated, (right) AI-NLS residuals map, top (K1), bottom (TBV).

### DETAILED DESCRIPTION OF THE INVENTION

There is an unmet need in the art to improve radioisotope imaging procedures to estimate and/or predict small regional dysfunction or disorders related to the myocardial blood flow (MBF) and/or myocardial flow reserve (MFR), wherein the image series fit to a one-tissue-compartment model yielding voxel-wise parametric maps comparing the projected data onto a two-dimensional (2D) polar map of the organ of interest such as left ventricle (LV) myocardium. The inventors of the present invention surprisingly found an advantage in producing regional flow and reserve values, which may better highlight small regional flow defects and are independent of LV polar-map segmentation. The inventors of the present invention found that by using an alternative 3D parametric imaging method of myocardial perfusion with radioisotopes, one can accurately estimate and/or predict the myocardial blood flow (MBF) and/or myocardial flow reserve (MFR). The present invention can be more readily understood by reading the following detailed description of the invention and included embodiments.

As used herein, the articles “a,” “an,” “the,” and “said” are intended to mean that there are one or more of the elements. The terms used herein “comprising,” “including,” and “having” are intended to be inclusive and mean that there may be additional elements other than the listed elements. Further, any numerical examples in the following discussion are intended to be non-limiting, and thus additional numerical values, ranges, and percentages are within the scope of the disclosed embodiments.

As used herein, the term “imaging” refers to techniques and processes used to create images of various parts of the human body for diagnostic and treatment purposes within digital health. X-ray radiography, Fluoroscopy, Magnetic resonance imaging (MRI), Computed Tomography (CT), Medical Ultrasonography or Ultrasound Endoscopy Elastography, Tactile imaging, Thermography Medical photography, and nuclear medicine functional imaging techniques e.g. Positron Emission Tomography (PET), Dynamic Positron Emission Tomography or Single-photon Emission Computed Tomography (SPECT). Imaging seeks to reveal internal structures of the body, as well as to diagnose and treat disease.

As used herein, the term “Positron Emission Tomography (PET)” refers to a functional imaging technique that uses radioactive substances known as radiotracers or radionuclides to visualize and measure changes in metabolic processes, and in other physiological activities including blood flow, regional chemical composition, and absorption. Different tracers can be used for various imaging purposes, depending on the target process within the body; commonly used radionuclide isotopes for PET imaging include Rb-82 (Rubidium-82), Water O-15 (Oxygen-15), F-18 (Fluorine-18), Ga-68 (Gallium-68), Cu-61 (Copper-61), C-11 (Carbon-11), N-13 (Ammonia-13), Co-55 (Cobalt-55), Zr-89 (Zirconium-89), Cu-62, Cu-64, 1-124, Tc-99m (Technetium), T1-201 (Thallium-201), and FDG (Fluorodeoxyglucose). The preferred radionuclide comprises Rb-82 having a half-life of 75 seconds.

As used herein, the term “SPECT” refers to Single-photon emission computed tomography, which is a nuclear medicine tomographic imaging technique using gamma rays and provides true 3D information. This information is typically presented as cross-sectional slices through the patient, but can be freely reformatted or manipulated as required. The technique requires delivery of a gamma-emitting radioisotope (a radionuclide) into the patient, normally through injection into the bloodstream. A marker radioisotope is generally attached to a specific ligand to create a radioligand, whose properties bind it to certain types of tissues. This allows the combination of ligand and radiopharmaceutical to be carried and bound to a region of interest in the body, where the ligand concentration is assessed by a gamma camera. SPECT agents include ^{99m}Tc technetium-99m (^{99m}Tc)-sestamibi, and ^{99m}Tc-tetrofosmin), In-111, Ga-67, Ga-68, Tl-201 (Thallium-201).

As used herein, the term “diagnosis” refers to a process of identifying a disease, condition, or injury from its signs and symptoms. A health history, physical exam, and tests, such as blood tests, imaging, scanning, and biopsies can be used to help make a diagnosis.

As used herein, the term “assessment” refers to a qualitative and/or quantitative assessment of the blood perfusion in a body part or region of interest (ROI).

As used herein, the term “stress agent” refers to agents used to generate stress in a patient or a subject during imaging procedure. The stress agents according to the present invention are selected from vasodilator agent, for example adenosine, adenosine triphosphate and its mimetic, A2A adenosine receptor agonist, for example regadenoson or adenosine reuptake inhibitor dipyridamole, other pharmacological agent, to increase blood flow to the heart, like catecholamines (for example dobutamine, acetyl-choline, papaverine, ergovine, etc.) or other external stimuli to increase blood flow to the heart such as cold-pressor, mental stress or physical exercise.

As used herein, the term “automated infusion system” or “radionuclide generation” and/or “infusion system” or “Rb-82 elution system” refers to system for generation and/or infusion of a radionuclide or radiotracer and administration into a subject. The automated infusion system comprises radioisotope generator, dose calibrator, computer, controller, display device, activity detector, cabinet, cart, waste bottle, sensors, shielding assembly, alarms or alerts mechanism, tubing, source vial, diluent or eluant, valves. The automated infusion system can be communicatively or electronically coupled to imaging system.

As used herein, the term “dose” refers to the dose of radionuclide required to perform imaging in a subject. The dose of a radionuclide to be administered into the subject ranges from 0.01 MBq to 10,000 MBq.

As used herein, the term “coronary artery disease” or “cardiovascular disease” refers to a disease of major blood vessels. Cholesterol-containing deposits (plaques) in coronary arteries and inflammation are causes of coronary artery disease. The coronary arteries supply blood, oxygen and nutrients to the heart. A buildup of plaque can narrow these arteries, decreasing blood flow to the heart. Eventually, the reduced blood flow may cause chest pain (angina), shortness of breath, or other coronary artery disease signs and symptoms. Significant blockage of the arteries can cause a heart attack. It can be diagnosed by imaging of the myocardium and/or myocardial blood flow (MBF) under rest or pharmacologic stress conditions to evaluate regional myocardial perfusion.

As used herein, the term “myocardial blood flow (MBF)” can be defined as the volume of blood transiting through tissue at a certain rate. MFR constitutes the ratio of MBF during maximal coronary vasodilatation to resting MBF and is therefore impacted by both rest and stress flow. MFR represents the relative reserve of the coronary circulation.

As used herein, the term “pharmacokinetic model” refers to a hypothesis using mathematical terms to describe quantitative relationships and is efficient in describing the time course of the drug throughout the body and is helpful in computing and calculating desired pharmacokinetic parameters, which are needed for achieving the overall objective of drug therapy. The process and kinetics involved in drug distribution and disposition are complex, and drug events often happen simultaneously. The process is governed by a variety of factors that must be properly defined and quantified for designing optimum drug therapy regimens through pharmacokinetic models. The pharmacokinetic model herein of the present invention is used to estimate the pharmacokinetic parameters such as K1, k2, TBV and the like. The term refers herein to the present invention, wherein the pharmacokinetic model can be selected from the group consisting of heart, brain, kidneys, lower extremities and/or combinations thereof.

As used herein, the term “radionuclide” or “radioisotope” refers to an unstable form of a chemical element that releases radiation as it breaks down and becomes more stable. Radionuclides can occur in nature or can be generated in a laboratory. In medicine, they are used in imaging tests and/or in treatment.

As used herein, the term “Sr/Rb elution system” or “⁸²Sr/⁸²Rb elution system” refers to infusion systems meant for generating a solution containing Rb-82, measuring the radioactivity in the solution, and infusing the solution into a subject in order to perform various studies on the subject's region of interest.

As used herein, the term “image counts” refers to number of radioisotope disintegrations acquired per unit time by the PET scanner.

As used herein, the term “generator” or “radioisotope generator” refers to a hollow column inside a radio-shielded container. The column is filled with an ion exchange resin and radioisotope loaded onto the resin. Radionuclide generator according to the present invention is selected from ⁹⁹Mo/^{99m}Tc, ⁹⁰Sr/⁹⁰Y, ⁸²Sr/⁸²Rb, ¹⁸⁸W/¹⁸⁸Re, ⁶⁸Ge/⁶⁸Ga, ⁴²Ar/⁴²K, ⁴⁴Ti/⁴⁴Sc, ⁵²Fe/^{52m}Mn, ⁷²Se/⁷²As, ⁸³Rb/^{83m}Kr, ¹⁰³Pd/^{103m}Rh, ¹⁰⁹Cd/^{109m}Ag, ¹¹³Sn/^{113m}In, ¹¹⁸Te/¹¹⁸Sb, ¹³²Te/¹³²I, ¹³⁷Cs/^{137m}Ba, ¹⁴⁰Ba/¹⁴⁰La, ¹³⁴Ce/¹³⁴La, ¹⁴⁴Ce/¹⁴⁴Pr, ¹⁴⁰Nd/¹⁴⁰Pr, ¹⁶⁶Dy/¹⁶⁶Ho, ¹⁶⁷Tm/^{167m}Er, ¹⁷²Hf/¹⁷²Lu, ¹⁷⁸W/¹⁷⁸Ta, ¹⁹¹Os/^{191m}Ir, ¹⁹⁴Os/¹⁹⁴Ir, ²²⁶Ra/²²²Rn and ²²⁵Ac/²¹³Bi, ⁶⁴Zn/⁶¹Cu.

As used herein, the term “eluant” refers to the liquid or the fluid used for selectively leaching out the daughter radioisotopes from the generator column.

As used herein, the term “eluate” refers to the radioactive eluant after acquisition of daughter radioisotope from the generator column.

As used herein, the term “controller” refers to a computer or a part thereof programmed to perform certain calculations, execute instructions, and control various activities of an elution system based on user input or automatically.

As used herein, the term “activity detector” refers to a component that is used to determine the amount of radioactivity present in eluate from a generator, e.g., prior to the administration of the eluate to the patient.

As used herein, the term “Convolutional Neural Network (CNN)” refers to a system that resembles feed forward neural systems. It is a type of artificial neural network used in time series and image and processing that is specifically designed to process pixel data. In deep learning, a convolutional neural network (CNN/ConvNet) is a class of deep neural networks, most commonly applied to analyze time series as well as natural or medical images. The blood input function is extracted from a region of interest (ROI) using manual or automatic procedures. The mean signal within the ROI is extracted at every time point creating a 1D signal blood input function.

As used herein, the term “Multi-layer perceptron (MLP)” refers to the Multilayer Perceptron, and is an example of an artificial neural network that is used extensively for the solution of a number of different problems, including pattern recognition and interpolation.

As used herein, the term “Recurrent neural network (RNN)” refers to a special type of an artificial neural network adapted to work for time series data or data that involves sequences. Ordinary feed forward neural networks are only meant for data points, which are independent of each other. The RNN method can be Long short-term memory (LSTM) or Gated Recurrent Unit (GRU) network. RNNs can work in conjunction with CNNs to form networks, such as the CNN-LSTM.

As used herein, the term “Gated Recurrent Unit (GRU)” refers to a type of Recurrent Neural Network (RNN) and uses less memory. It is a part of a specific model of recurrent neural network that intends to use connections through a sequence of nodes to perform machine learning tasks associated with memory and clustering. It has a gating mechanism in recurrent neural networks.

As used herein, the term “voxel” refers to a value on a regular grid in three-dimensional space in three-dimensional (3D) computer graphics. Voxel is short for volume pixel, the smallest distinguishable cube-shaped part of a 3D image. Voxelization is the process of adding depth to an image using a set of cross-sectional images known as a volumetric dataset. These cross-sectional images (or slices) are made up of pixels. Pulling pixels and slices together, a three-dimensional (3D) partition of the image space into volume elements (voxels) forming a 3D scalar field.

As used herein, the term “Tissue Response Function (TRF)” refers to a tracer kinetic modelling, which is used to estimate physiological parameters such as myocardial blood flow (MBF) by mapping or transforming the shape of the “arterial input function (AIF)” to the shape of TRF.

As used herein, the term “blood input function” is commonly known as arterial input function (AIF), which is defined as the concentration of the tracer in an artery measured over time by placing a region of interest.

An embodiment of the present invention includes an image processing method to assess quantitative myocardial blood flow and myocardial flow reserve, comprising the steps of:
a. pre-processing of images comprises:
(i) reconstructing dynamic cine 3D tomographic myocardial perfusion imaging (MPI) data,
(ii) isolating value at voxel (i,j,k) for each time point t; where i is from 1 to N,
(iii) optionally, denoising to improve the quality of image,
(iv) extracting blood input function from a region of interest (ROI) of the left ventricle blood cavity or other arterial blood region of interest (ROI),
(v) estimating the distribution volume (DV), given by the ratio of uptake and washout rates (K₁/K₂) to stabilize and improve estimation of K₁, K₂ and total blood volume (TBV) and subsequent myocardial blood flow measures, and
(vi) data normalization by dividing by the maximum of the blood input function
b. assessing the individual signals pre-processed in step (a) in order to generate K₁ and TBV parametric maps using artificial neural network;
c. post-processing of K₁, K₂ . . . Kₙ, X², R², distribution volume (DV) and TBV parametric maps, and of rest and stress myocardial blood flow to estimate myocardial flow reserve (MFR) and/or coronary flow reserve (CFR).

In an embodiment of the present invention, the image processing method is used to assess quantitative myocardial blood flow and myocardial flow reserve, wherein the image reconstruction of arrays is a dynamic series comprising the 3D tomographic voxel (i,j,k) from PET reconstruction for the number of time steps, ti, where i is from 1 to N.

Another embodiment of the present invention includes use of the image processing method to assess quantitative myocardial blood flow and myocardial flow reserve, wherein a region of interest (ROI) can be manual and/or automatic procedures.

In another embodiment of the present invention, the image processing method is used to assess quantitative myocardial blood flow and myocardial flow reserve, wherein the data normalization is performed by dividing by the maximum of the blood input function.

In an embodiment of the present invention, the image processing method is used to assess quantitative myocardial blood flow and myocardial flow reserve, wherein the data normalization for blood input function is performed with the value being from 0 to 1.

In another embodiment of the present invention, the image processing method is used to assess quantitative myocardial blood flow and myocardial flow reserve, wherein the input signal enters a multi-layer perceptron and/or an artificial neural network and/or generative adversarial network (GANs) and/or convolutional neural network (CNN) and/or long short term memory (LSTM) network to simultaneously predict uptake rate (K₁), washout rate (K₂), distributed volume (DV), and total blood volume (TBV).

In another embodiment of the present invention, the image processing method is used to assess quantitative myocardial blood flow and myocardial flow reserve, wherein the images produced regional flow and reserve values to highlight small regional flow defects.

In an embodiment of the present invention, the image processing method is used to assess quantitative myocardial blood flow and myocardial flow reserve, wherein the artificial neural networks are selected from the group consisting of, multi-layer perceptron (MLP), artificial neural network (ANN), convolutional neural network (CNN), recurrent neural network (RNN), long short-term memory recurrent neural network (LSTM-RNN), gated recurrent unit (GRU) network, deep machine learning and/or combinations thereof.

In another embodiment of the present invention, the image processing method is used to assess quantitative myocardial blood flow and myocardial flow reserve, wherein to estimate distribution volume (DV) artificial neural network enter in multiple layers and wherein the multiple layers can be selected from the group consisting of the initial layer of the network, at an intermediate layer, at the penultimate layer, or combinations thereof.

Another embodiment of the present invention includes the image processing method to assess quantitative myocardial blood flow and myocardial flow reserve, wherein the model predicts a K₂ (washout rate) value.

In another embodiment of the present invention, the image processing method is used to assess quantitative myocardial blood flow and myocardial flow reserve, wherein anisotropic diffusion filtering is with Gaussian filter.

In an embodiment of the present invention, the image processing method is used to assess quantitative myocardial blood flow and myocardial flow reserve, wherein estimating K₁, K₂ and total blood volume (TBV) by performing on a voxel-wise basis using 1D signal CNN-LSTM to produce more accurate myocardial blood flow (MBF) estimations.

In another embodiment of the present invention, the image processing method is used to assess quantitative myocardial blood flow and myocardial flow reserve, wherein the images are characterized by administering Rb-82, O-15, N-13, F-18, Cu-62, Tc-99m, Tl-201, and/or combinations thereof.

In an embodiment of the present invention, the image processing method is used to assess quantitative myocardial blood flow and myocardial flow reserve, wherein the images are characterized by administering Rb-82 in rest and stress PET perfusion imaging to highlights small regional flow defects.

In an embodiment of the present invention, the image processing method is used to assess quantitative myocardial blood flow and myocardial flow reserve, wherein the imaging agent or radionuclide is administered by automated generation and infusion system and/or intravenous administration of radiopharmaceuticals produced by fission, neutron activation, cyclotron and/or generator.

In an embodiment of the present invention, the image processing method is used to assess quantitative myocardial blood flow and myocardial flow reserve, wherein automated radioisotope generation and infusion system comprises Rb-82 elution system.

In another embodiment of the present invention, the image processing method is used to assess quantitative myocardial blood flow and myocardial flow reserve, wherein the images obtained fit to one-tissue-compartment model or multi-tissue compartment model by predicting the value of the ratio of myocardial blood flow stress and myocardial blood flow rest to determine myocardial flow reserve and/or coronary flow reserve and wherein performing an assessment of the obtained images to diagnose disease state using multi-layer perceptron (MLP), artificial neural network (ANN), convolutional neural network (CNN), recurrent neural network (RNN), long short-term memory recurrent neural network (LSTM-RNN), gated recurrent unit (GRU) network, deep machine learning, deep neural network, artificial neural network and/or combinations thereof.

In an embodiment of the present invention, the image processing method is used to assess quantitative myocardial blood flow and myocardial flow reserve, wherein the imaging comprises positron emission tomography (PET) imaging, dynamic positron emission tomography, single-photon emission computerized tomography (SPECT), magnetic resonance imaging (MRI), computed tomography (CT), and/or combinations thereof.

In an embodiment of the present invention, an image processing method is used to assess quantitative myocardial blood flow and myocardial flow reserve, comprising the steps of:
a. pre-processing of images comprises:
(i) reconstructing dynamic cine 3D tomographic myocardial perfusion imaging (MPI) data
(ii) isolating value at voxel (i,j,k) for each time point t; where i is from 1 to N,
(iii) optionally, denoising to improve the quality of image,
(iv) extracting blood input function from a region of interest (ROI) of the left ventricle blood cavity or other arterial blood region of interest,
(v) estimating the distribution volume (DV), given by the ratio of uptake and washout rates (K₁/K₂) to stabilize and improve estimation of K₁, K₂ and total blood volume (TBV) and subsequent myocardial blood flow measures, and
(vi) data normalization by dividing by the maximum of the blood input function;
b. applying the time series at voxel (i,j,k) and blood input function to artificial intelligence network simultaneously to predict uptake K₁, K₂ and TBV,
c. post-processing of K₁, K₂ and TBV parametric maps comprises:
(i) partial volume correction,
(ii) extraction fraction to estimate myocardial blood flow (MBF) at rest and stress; and
d. post-processing of rest and stress myocardial blood flow to estimate myocardial flow reserve (MFR) and/or coronary flow reserve (CFR).

Another embodiment of the present invention includes an image processing method to assess quantitative myocardial blood flow and myocardial flow reserve, comprising the steps of:
a. pre-processing of images comprises:
(i) reconstructing dynamic cine 3D tomographic myocardial perfusion imaging (MPI) data,
(ii) isolating value at voxel (i,j,k) for each time point t; where i is from 1 to N,
(iii) optionally, denoising to improve the quality of image,
(iv) extracting blood input function from a region of interest (ROI) of the left ventricle blood and other arterial blood region of interest,
(v) estimating the distribution volume (DV), given by the ratio of uptake and washout rates (K₁/K₂) to stabilize and improve estimation of K₁, K₂ and total blood volume (TBV) and subsequent myocardial blood flow measures, and
(vi) data normalization by dividing by the maximum of the blood input function;
b. applying the time series at voxel (i,j,k) and blood input function to artificial intelligence network simultaneously to predict uptake K₁, K₂ and TBV,
c. post-processing of K₁, K₂ and TBV parametric maps comprises:
(i) partial volume correction,
(ii) extraction fraction to estimate myocardial blood flow (MBF) at rest and stress; and
d. post-processing of rest and stress myocardial blood flow to estimate myocardial flow reserve (MFR) and/or coronary flow reserve (CFR);
wherein the artificial neural networks are selected from the group consisting of, multi-layer perceptron (MLP), artificial neural network (ANN), convolutional neural network (CNN), recurrent neural network (RNN), long short-term memory recurrent neural network (LSTM-RNN), gated recurrent unit (GRU) network, Generative adversarial networks (GANs), deep machine learning and/or combinations thereof.

Another embodiment of the present invention includes an image processing method to assess quantitative myocardial blood flow and myocardial flow reserve, comprising the steps of:
a. pre-processing of images comprises:
(i) reconstructing dynamic cine 3D tomographic myocardial perfusion imaging (MPI) data,
(ii) isolating value at voxel (i,j,k) for each time point t; where i is from 1 to N,
(iii) optionally, denoising to improve the quality of image,
(iv) extracting blood input function from a region of interest (ROI) of the left ventricle blood cavity or other arterial blood region of interest (ROI),
(v) estimating the distribution volume (DV), given by the ratio of uptake and washout rates (K₁/K₂) to stabilize and improve estimation of K₁, K₂ and total blood volume (TBV) and subsequent myocardial blood flow measures, and
(vi) data normalization by dividing by the maximum of the blood input function;
b. applying the time series at voxel (i,j,k) and blood input function to artificial intelligence network simultaneously to predict uptake K₁ and TBV, wherein the average R² values are in between 0.9 to 1:
c. post-processing of K₁ and TBV parametric maps comprises:
(i) partial volume correction,
(ii) extraction fraction to estimate myocardial blood flow (MBF) at rest and stress; and
d. post-processing of rest and stress myocardial blood flow to estimate myocardial flow reserve (MFR) map and/or coronary flow reserve (CFR) map;
wherein the artificial neural networks are selected from the group consisting of, multi-layer perceptron (MLP), artificial neural network (ANN), convolutional neural network (CNN) and/or 1D convolutional neural network (1D-CNN), recurrent neural network (RNN), long short-term memory recurrent neural network (LSTM-RNN), gated recurrent unit (GRU) network, generative adversarial networks (GANs), deep machine learning and/or combinations thereof.

Another embodiment of the invention includes a method for computing an arterial input function from region of interest, wherein the artificial neural networks construct a Convolutional Long-Short Term Memory (ConvLSTM)-U-Net to take as input reconstructed 4D dynamic PET data and output a 3D probability map for deriving a weighted average AIF by multiplying the probability map to the PET data for each time frame. The proposed AIF along with tissue time activity curves (TACs) of a target organ as disclosed herein the present invention, the LV were used for kinetic modeling of the 1TCM using a second, previously trained AI model. Unlike classical non-linear least squares regression for kinetic modeling, the second AI model can estimate uptake (K1) and fractional blood volume (FBV) upon inference. The AI-derived K1 and FBV values re-entered the 1TCM in order to generate theoretical TACs and were compared to the observed LV TACs to calculate a mean squared error (MSE) loss function. This end-to-end training architecture allowed for the MSE error to be back-propagated through the ConvLSTM-U-Net for model updating. In this way, the ConvLSTM-U-Net learns to derive a AIF specific to the TACs of a target organ without any a priori anatomical knowledge or human annotation.

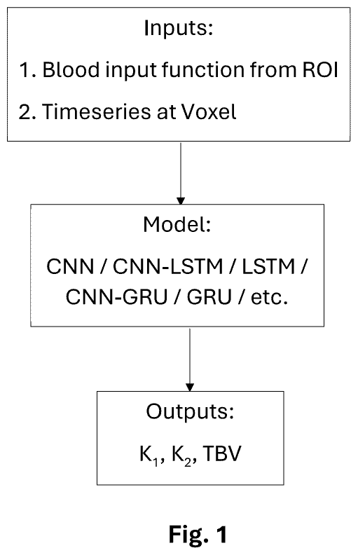

FIG. 1 illustrates the flow diagram, wherein the model takes blood input function, the timeseries at voxel for output K₁, K₂ and TBV (total blood volume).

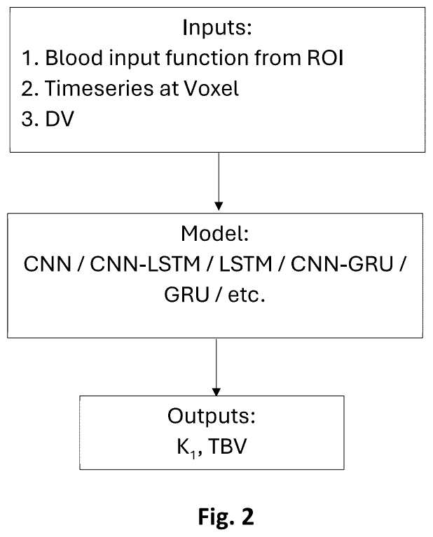

The flow diagram of FIG. 2 illustrates the model that takes blood input function, the timeseries at voxel, distribution volume (DV) for output K₁ and TBV (total blood volume).

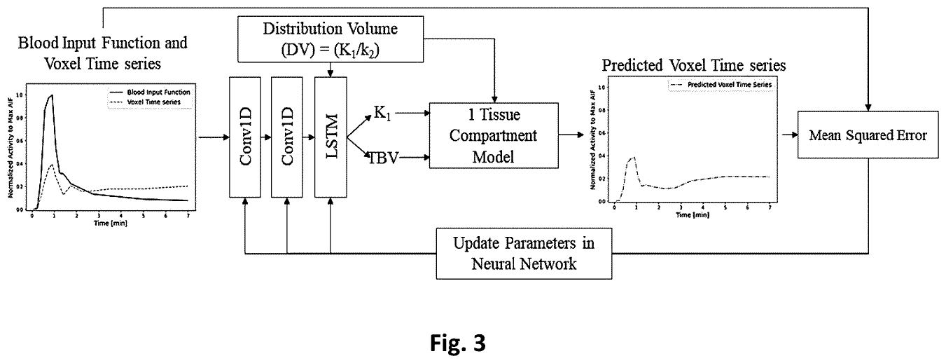

FIG. 3 illustrates the flow diagram for model training, wherein the model takes blood input function, time series at voxel, and distribution volume (DV) for output K₁ and TBV (total blood volume). K₁, TBV, and DV are inputs to the one tissue compartment model which yields a predicted voxel time series. The mean squared error between the predicted and input voxel time series is computed and feedback to the model to update model parameters.

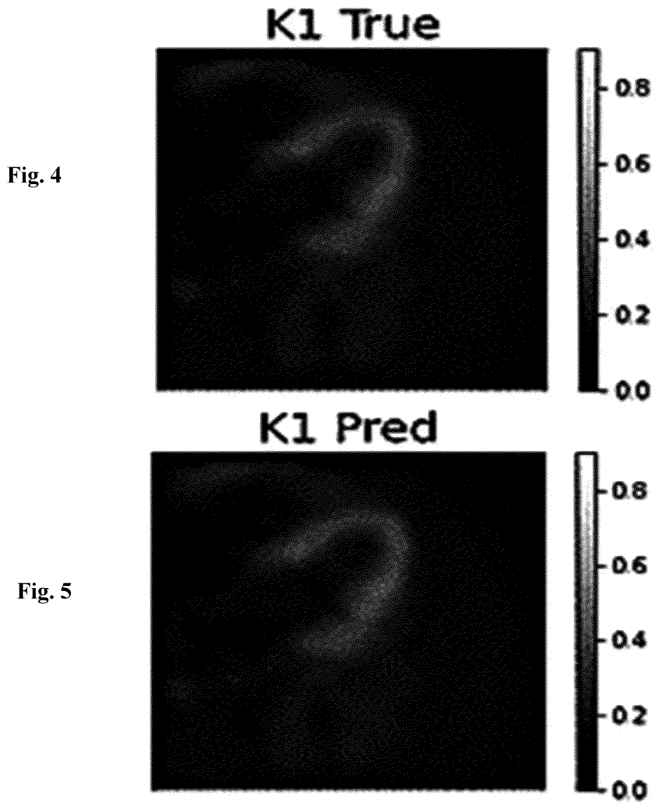

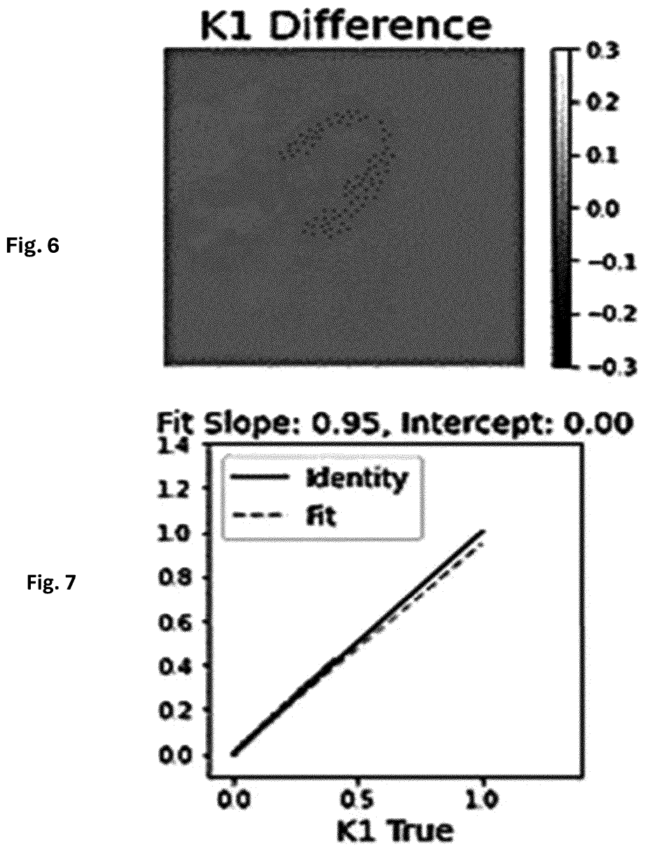

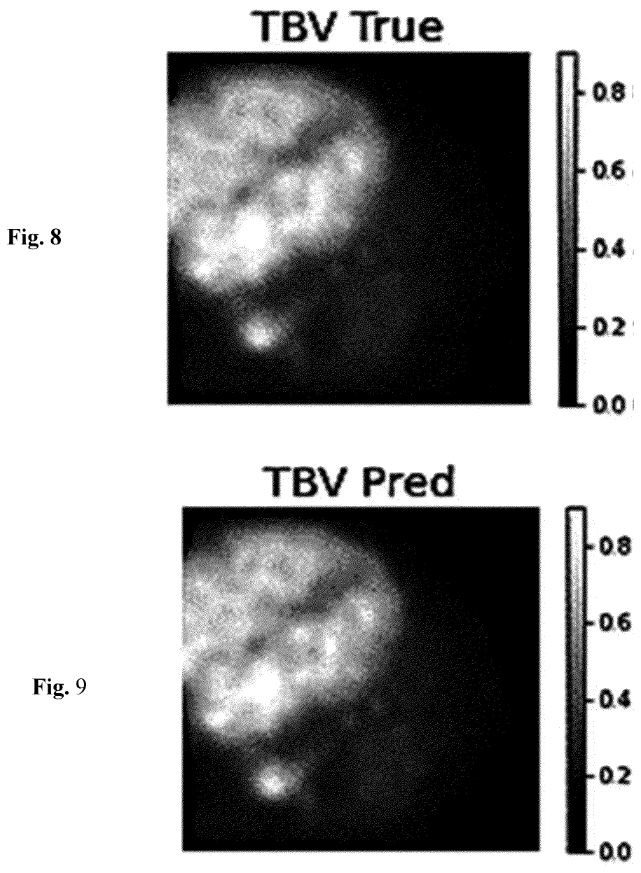

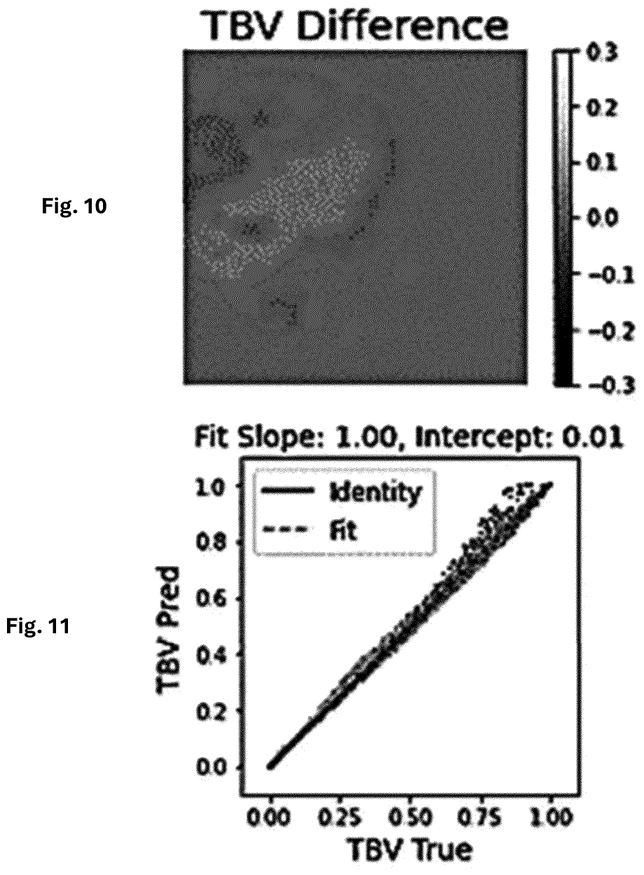

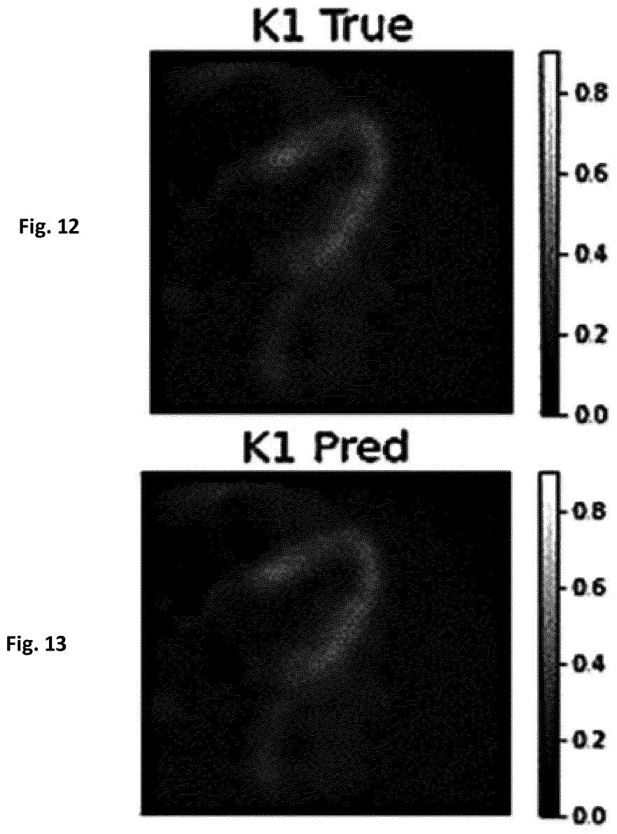

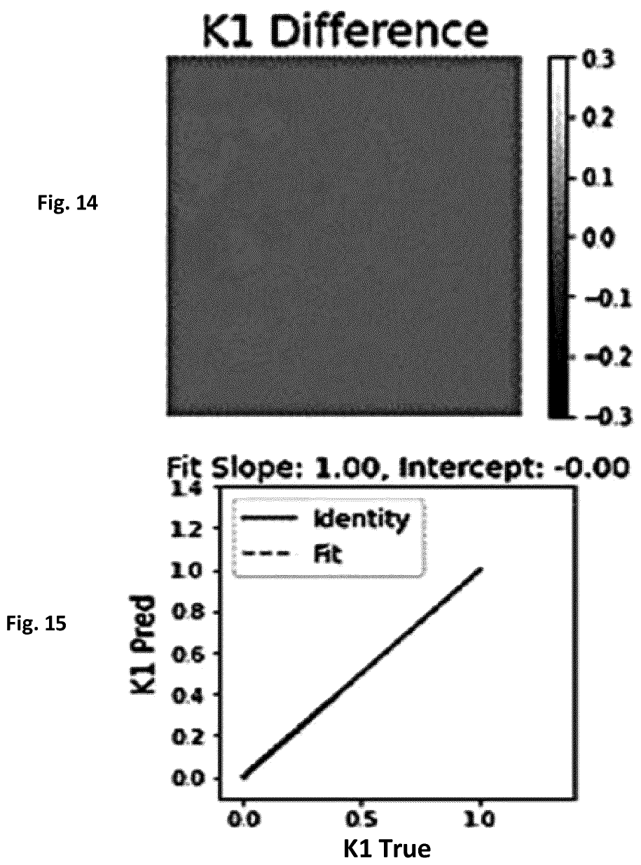

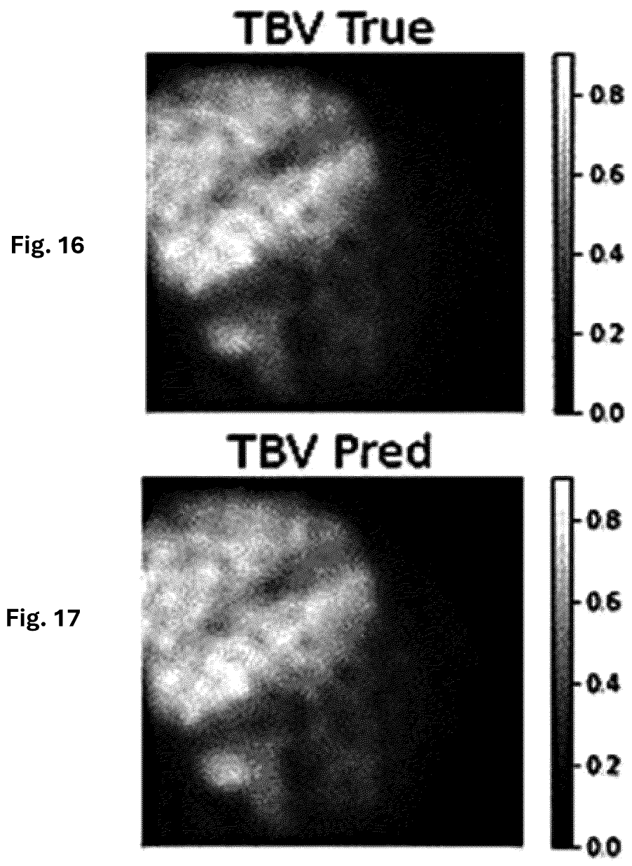

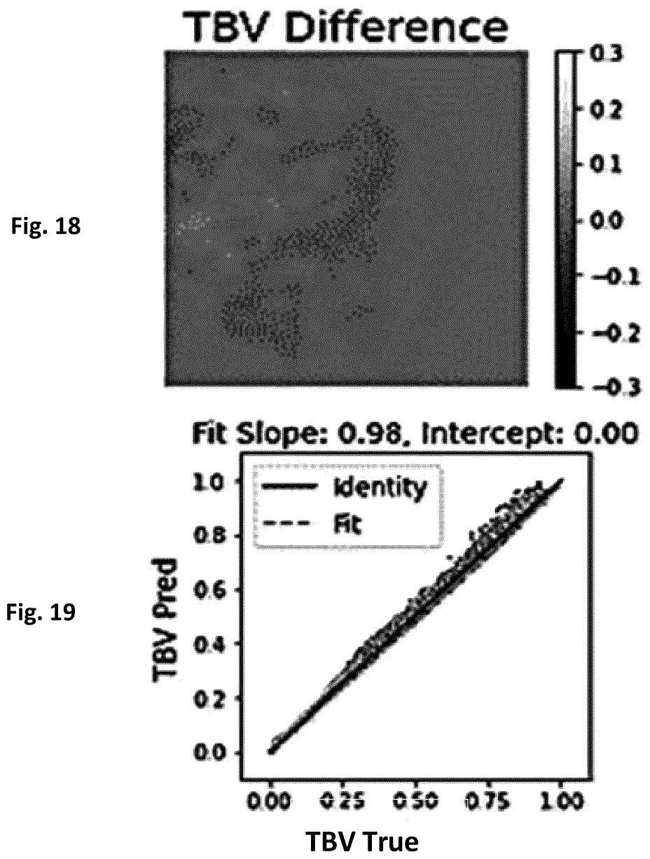

FIGS. 4-19 represent the ground truth vs AI-generated parametric maps. FIGS. 4-11 report the results for a patient's ⁸²Rb Stress scan. Ground Truth K1 parametric maps from non-linear least squares method is depicted as K1 True (shown in FIG. 4), the predicted K1 map from the AI model is depicted as K1 Predicted (K1 15 pred.) (shown in FIG. 5), the difference between K1 True and K1 Pred. is depicted as K1 difference (K1 diff.) (shown in FIG. 6), and a correlation between the whole image K1 True vs K1 Pred. images (shown in FIG. 7). In FIG. 7 the solid line is the identity line and the dotted line is the fit of the correlation. FIGS. 12-19 report the results for a patient's ⁸²Rb rest scan. Ground Truth K1 parametric maps from non-linear ₂₀ least squares method (K1 True) (shown in FIG. 12), the predicted K1 map from the AI model (K1 Pred.) (shown in FIG. 13), the difference between K1 True and K1 Pred. (K1 difference) (shown in FIG. 14), and a correlation between the whole image K1 True vs K1 Pred. images (shown in FIG. 15). In FIG. 15 the solid line is the identity line and the dotted line is the fit of the correlation.

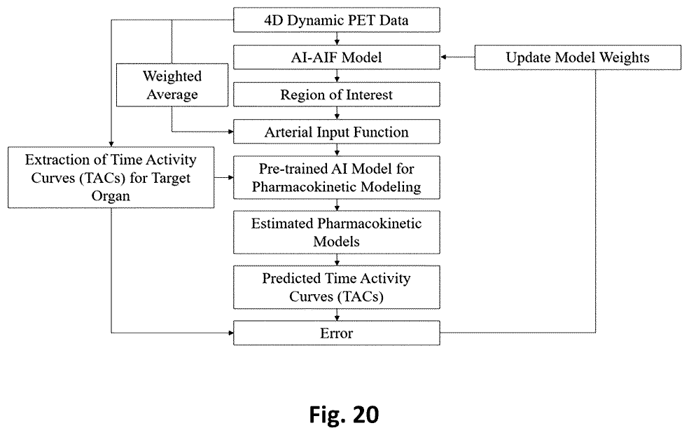

FIG. 20 represents a workflow for training the AI-AIF segmentation network in unsupervised learning way. Obtaining a plurality of dynamic image data sets comprising volumetric image data from region of interest over multiple scanning intervals; utilizing an artificial neural network to segment the plurality of dynamic image data sets displaying one or more arterial input function(s) (AIF) in the region(s) of interest; automatically estimating, using the artificial intelligence, an arterial input function based on a plurality of dynamic image data sets combined with one or more time activity curves (TAC) in the region(s) of interest in target organ(s); computing a pre-trained predictive pharmacokinetic AI model arterial input function using time activity curve input associated with region(s) of interest of target organ(s) and the estimated pharmacokinetic model is used to generate the predicted time activity curves by using the pre-trained pharmacokinetic model.

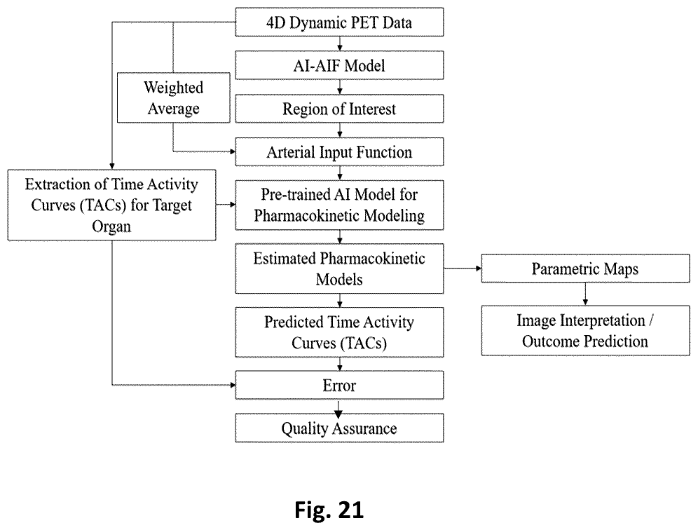

FIG. 21 represents a workflow to use the trained AI-AIF segmentation network for quality assurance of the algorithm and for generating parametric maps used for image interpretation or outcome prediction.

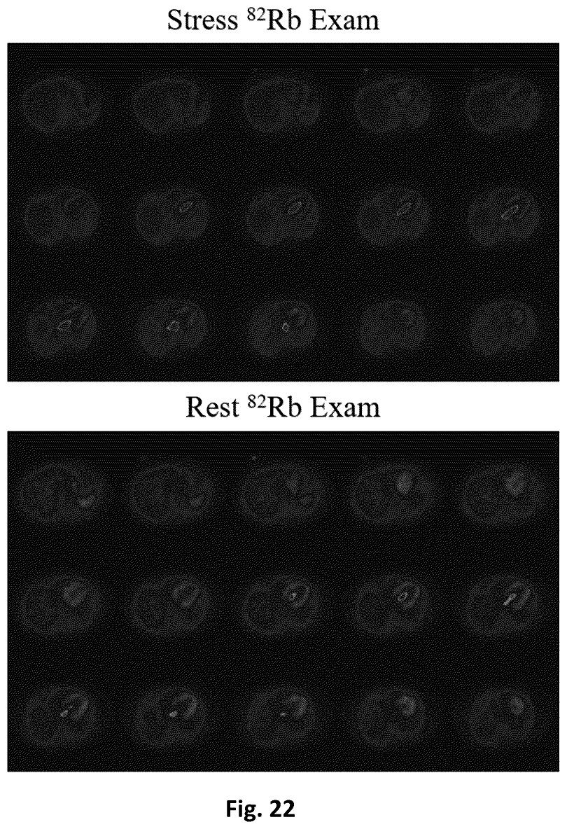

FIG. 22 represents AI-derived ROIs superimposed on a representative patient's stress and rest 82Rb exams wherein the ROI is automatically placed on a region spanning the left and right ventricle.

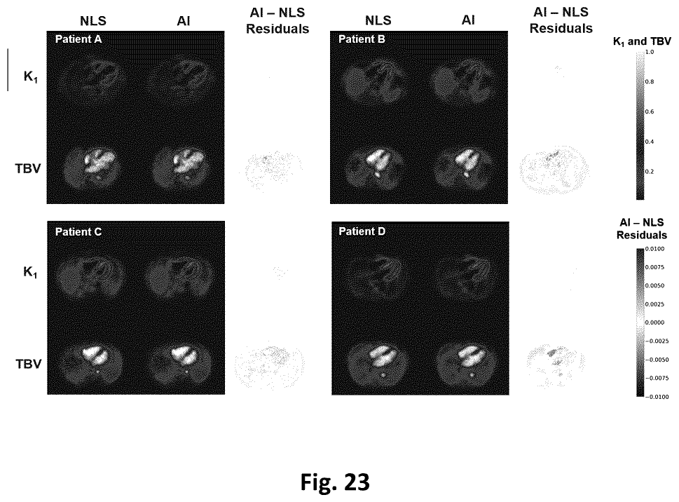

FIG. 23 represents agreement between K1 and TBV parametric maps of four test patients' stress images using reference nonlinear least squares (NLS) curve fitting vs. AI. For each panel: (left) NLS reference map, (middle) AI generated, (right) AI-NLS residuals map, top (K1), bottom (TBV).

An embodiment of the present invention includes use of the image processing method to assess quantitative myocardial blood flow and myocardial flow reserve, wherein consistent image quality is observed in the dose range of Rb-82 is about 1 MBq to about 10,000 MBq.

In an embodiment of the present invention, the image processing method is used to assess quantitative myocardial blood flow and myocardial flow reserve, wherein the imaging comprises X-ray radiography, Fluoroscopy, Magnetic resonance imaging (MRI), Computed Tomography (CT), Medical Ultrasonography or Ultrasound Endoscopy Elastography, Tactile imaging, Thermography Medical photography, and nuclear medicine functional imaging techniques e.g. positron emission tomography (PET), dynamic positron emission tomography, single-photon emission computed tomography (SPECT) imaging and/or combinations thereof.

Another embodiment of the present invention includes the image processing method to assess quantitative myocardial blood flow and myocardial flow reserve, wherein the dose of the imaging agent to be administered is calculated by automated generation and infusion system.

In another embodiment of the present invention, the image processing method is used to assess quantitative myocardial blood flow and myocardial flow reserve, wherein the input signal is enters multi-layer perceptron (MLP), artificial neural network (ANN), convolutional neural network and/or Long Short Term Memory (LSTM) network to simultaneously predict uptake rate (K₁), washout rate (K₂) and total blood volume (TBV), and wherein performing an assessment of the obtained images to diagnose disease state using deep neural network, artificial neural network, deep machine learning or combinations thereof.

In an embodiment of the present invention the image processing method is used to assess quantitative myocardial blood flow and myocardial flow reserve, wherein administering and performing the test, the steps comprise:
(a) generating a sufficient amount of Rb-82 by automated elution system of Sr-82/Rb-82 radionuclide generator;
(b) administering the generated dose of Rb-82 to the patient;
(c) performing a suitable imaging procedure to obtain better quality images of small regions; and
(d) performing an assessment of the obtained images to diagnose disease state using deep neural network, artificial neural network, deep machine learning, convolutional neural network, recurrent neural network, long short-term memory recurrent neural network (LSTM-RNN), generative adversarial networks (GANs), gated recurrent unit (GRU) network and/or combinations thereof.

An embodiment of the present invention includes using the image processing method to assess quantitative myocardial blood flow and myocardial flow reserve, wherein the method may further comprise administering a stress agent to the subject.

Another embodiment of the present invention includes the image processing method used to assess quantitative myocardial blood flow and myocardial flow reserve, wherein the stress can be induced by administering a stress agent selected from adenosine, adenosine triphosphate, regadenoson, dobutamine, dipyridamole or exercise.

An embodiment of the present invention includes the image processing method used to assess quantitative myocardial blood flow and myocardial flow reserve, wherein the subject weight ranges from 1 kg to 300 kg, preferably in the range of 20 kg to 200 kg.

In an embodiment of the present invention, the image processing method is used to assess quantitative myocardial blood flow and myocardial flow reserve, wherein the automatic dose calculation further comprises other parameters selected from, type of radioisotope, radioisotope half-life, generator life (activity remaining in the radioisotope generator), generator yield, infusion time, flow rate, time lapse from generation to infusion of radioisotope, scanning instrument detector sensitivity, scanner resolution, type of camera or scanner, acquisition time, camera sensitivity, type of disease to be diagnosed, subject conditions like known allergies, heart function, liver function or kidney function or any other special need, subject's supplementary diseases, medications, type of imaging technique to be utilized like PET, SPECT, CT, MRI, and/or combinations thereof.

Another embodiment of the present invention includes the image processing method used to assess quantitative myocardial blood flow and myocardial flow reserve, wherein the automated generation and infusion system comprises a cabinet, radioisotope generator, dose calibrator, computer, controller, display device, activity detector, cabinet, cart, waste bottle, sensors, shielding assembly, alarms or alerts mechanism, tubing, source vial, diluent or eluant, valves or combinations thereof. The automated generation and infusion system generates a radionuclide from a generator/column placed inside the system. A radionuclide eluate is generated from the generator by eluting the generator with suitable eluant like saline, which is then administered by the system automatically after activity measurements. The dose is calculated automatically by the system based on the entered subject parameters. The system is equipped to calculate the flow rate and infusion time depending on the dose to be administered. The automated generation and infusion system can comprise any radionuclide generator, which is suitable for administration to a subject like ⁸²Sr/⁸²Rb generator.

An embodiment of the present invention includes using the image processing method to assess quantitative myocardial blood flow and myocardial flow reserve, wherein the automated generation and infusion system is coupled to the imaging system electronically or communicatively. The coupled imaging system can provide alerts in case image quality is not up to the mark and require repeated administration or scanning.

Another embodiment of the present invention includes using the image processing method to assess quantitative myocardial blood flow and myocardial flow reserve, wherein the automated generation and infusion system is embodied in a portable (or mobile) cart that houses some or all of the generator, the processor, the pump, the memory, the patient line, the bypass line, the positron detector, and/or the calibrator, sensors, dose calibrator, activity detector, waste bottle, controller, display, computer. The cart carrying the components for radioisotope generation and infusion is mobile and can be transferred from one place to another to the patient location or centers, hospitals as required.

An embodiment of the present invention includes using the image processing method to assess quantitative myocardial blood flow and myocardial flow reserve, wherein the method of diagnosing/imaging blood perfusion or flow in the region of interest comprising: input subject parameters into the radioisotope generation and infusion system; automatically calculating the appropriate dose; generating a radionuclide from automated generation or infusion system based on required dose to be administered; administering the radionuclide to the subject in need thereof; performing PET or SPECT scanning of the region of interest; automated analysis of the images by computerized software; quantitative assessment of the blood flow in the region of interest; generating automated report of the assessment; providing appropriate therapy options for the subject.

Another embodiment of the present invention includes using the image processing method to assess quantitative myocardial blood flow and myocardial flow reserve, wherein the subject is a human subject. The human subject is a male or female subject. The age of the subject may vary from 1 month to 120 years. The human subject includes neonates, pediatric, adults and/or geriatric population.

Another embodiment of the present invention includes using the image processing method to assess quantitative myocardial blood flow and myocardial flow reserve, wherein all numbers disclosed herein can vary by 1%, 2%, 5%, 10%, or up to 20% if the word “about” is used in connection therewith. This variation may be applied to all numbers disclosed herein.

Another embodiment of the present invention includes using the image processing method to assess quantitative myocardial blood flow and myocardial flow reserve, wherein 3D parametric images of MBF generated by present invention has better image quality and pixel. This invention also provides a recommendation alert to the medical staff regarding the detection of the coronary diseases by analyzing the generated 3D parametric images of MBF and/or MFR.

Another embodiment of the present invention includes using the image processing method to assess quantitative myocardial blood flow and/or myocardial flow reserve, wherein 3D parametric images of MBF generated by present invention also recommend the calcium scoring. The coronary artery calcium (CAC) score reflects the total area of calcium deposits and the density of the calcium. A score of zero means no calcium is seen in the heart. It suggests a low chance of developing a heart attack in the future. When calcium is present, the higher the score, the higher the risk of heart disease. To evaluate the accuracy and reproducibility of visual estimation of coronary artery calcium (CAC) positron emission tomography (PET), dynamic positron emission tomography (PET), hybrid positron emission tomography (PET), computed tomography (CT) and single-photon emission computed tomography (SPECT)/CT myocardial perfusion imaging (MPI) scans are performed.

Another embodiment of the present invention includes using the image processing method to assess quantitative myocardial blood flow and/or myocardial flow reserve, wherein the image reconstruction algorithms have been developed to improve the quality of images and using the AI algorithm to enhance the image reconstruction quality, which is intended to do the image processing faster and reduce the doses of nuclear medicine up to 10 times during the myocardial perfusion imaging (MPI).

Another embodiment of the present invention includes using the image processing method for AI models to generate blood flow parametric maps with high accuracy and in a timeframe acceptable for clinical use, which may enable future clinical implementation.

Another embodiment of the present invention includes using the image processing method to automatically compute an arterial input function from region of interest, the method comprising:
a. obtaining a plurality of dynamic image data sets comprising volumetric image data from region of interest over multiple scanning intervals;
b. utilizing an artificial neural network to segment the plurality of dynamic image data sets displaying one or more arterial input function(s) (AIF) in the region(s) of interest;
c. automatically estimating, using artificial intelligence, an arterial input function based on plurality of dynamic image data sets combined with one or more-time activity curves (TAC) in the region(s) of interest in target organ(s); and
d. computing a pre-trained predictive pharmacokinetic AI model arterial input function using time activity curve input associated with region(s) of interest of target organ(s).

Another embodiment of the present invention includes using the image processing method to automatically compute an arterial input function from region of interest, wherein the artificial neural network is a self-trained or un-supervised machine learning model.

Another embodiment of the present invention includes using the image processing method to automatically compute an arterial input function from region of interest, wherein artificial neural networks is selected from the group consisting of multi-layer perceptron (MLP), artificial neural network (ANN), convolutional neural network (CNN) and/or 1D convolutional neural network (1D-CNN), recurrent neural network (RNN), long short-term memory recurrent neural network (LSTM-RNN), gated recurrent unit (GRU) network, generative adversarial networks (GANs), deep machine learning, reinforcement learning algorithm and/or combinations thereof.

Another embodiment of the present invention includes using the image processing method to automatically compute an arterial input function from region of interest, wherein the pre-trained predictive pharmacokinetic AI model is used the estimate the pharmacokinetic parameters.

Another embodiment of the present invention includes using the image processing method to automatically compute an arterial input function from region of interest, wherein the pharmacokinetic modelling can be selected from the group consisting of one, two, three, or four tissue compartment model.

Another embodiment of the present invention includes using the image processing method to automatically compute an arterial input function from region of interest, wherein the pharmacokinetic AI model can be selected from the group consisting of heart, brain, kidneys, lower extremities and/or combinations thereof.

Another embodiment of the present invention includes using the image processing method to automatically compute an arterial input function from region of interest, wherein the one, two, three, or four tissue compartment model estimates the K₁, k2, fractional blood volume, total blood volume and/or combinations thereof.

Another embodiment of the present invention includes using the image processing method to automatically compute an arterial input function from region of interest, wherein the image data is characterized by administering Rb-82, O-15, N-13, Cu-62-PTSM, 99m-Tc-Sestamibi, Tl-201, and/or combinations thereof.

Another embodiment of the present invention includes using the image processing method to automatically compute an arterial input function from region of interest wherein the image-data is characterized by administering Rb-82 in rest and stress PET perfusion imaging to highlights small regional flow defects.

Another embodiment of the present invention includes using the image processing method to automatically compute an arterial input function from region of interest, wherein the imaging agent or radionuclide is administered by automated generation and infusion system and/or intravenous administration of radiopharmaceuticals produced by fission, neutron activation, cyclotron and/or generator.

Another embodiment of the present invention includes using the image processing method to automatically compute an arterial input function from region of interest, wherein automated radioisotope generation and infusion system comprises Rb-82 elution system.

Another embodiment of the present invention includes using the image processing method to automatically compute an arterial input function from region of interest, wherein the pre-trained predictive pharmacokinetic AI model is a self-trained or un-supervised machine learning model.

Another embodiment of the present invention includes using the image processing method to automatically compute an arterial input function from region of interest, wherein the method further comprises using the error of the predicted time activity curves from the observed time activity curves in the region of interest (ROI) for quality assurance.

Another embodiment of the present invention includes using the image processing method to automatically compute an arterial input function from region of interest, wherein the error is mean squared error (MSE) with a threshold value and mean squared error (MSE) is used to determine the reliability of the region of interest (ROI) and derived AIF.

Another embodiment of the present invention includes using the image processing method to automatically compute an arterial input function (AIF) from region of interest (ROI), wherein the method further comprises generating a parametric map using a trained AIF-ROI segmentation.

Another embodiment of the present invention includes using the image processing method to automatically compute an arterial input function (AIF) from region of interest (ROI), wherein the method further comprises generating a parametric maps using a trained AIF-ROI segmentation in combination with one or more parametric mapping method.

Another embodiment of the present invention includes using the image processing method to automatically compute an arterial input function (AIF) from region of interest (ROI), wherein the one or more parametric mapping methods can be selected from the group of nonlinear least squares regression, basis function method, AI-based model for pharmacokinetic modelling or combinations thereof.

Another embodiment of the present invention includes using the image processing method to automatically compute an arterial input function (AIF) from region of interest (ROI), the method comprising:
a. obtaining a plurality of dynamic image data sets comprising volumetric image data from region of interest over multiple scanning intervals;
b. utilizing an artificial neural network to segment the plurality of dynamic image data sets displaying one or more arterial input function(s) (AIF) in the region(s) of interest (ROI);
c. automatically estimating, using artificial intelligence, an arterial input function (AIF) based on plurality of dynamic image data sets combined with one or more-time activity curves (TAC) in the region(s) of interest (ROI) in target organ(s); and
d. computing a pre-trained predictive pharmacokinetic AI model arterial input function using time activity curve (TAC) input associated with region(s) of interest (ROI) of target organ(s);
wherein the pre-trained predictive pharmacokinetic AI model is used for estimating the associated parameter to determine the parametric map.

Another embodiment of the present invention includes using the image processing method to automatically compute an arterial input function (AIF) from region of interest (ROI) method comprising:
a. obtaining a plurality of dynamic image data sets comprising volumetric image data from region of interest (ROI) over multiple scanning intervals;
b. utilizing an artificial neural network to segment the plurality of dynamic image data sets displaying one or more arterial input function(s) (AIF) in the region(s) of interest (ROI);
c. automatically estimating, using the artificial intelligence, an arterial input function (AIF) based on plurality of dynamic image data sets combined with one or more-time activity curves (TAC) in the region(s) of interest (ROI) in target organ(s); and
d. computing a pre-trained predictive pharmacokinetic AI model arterial input function using time activity curve (TAC) input associated with region(s) of interest (ROI) of target organ(s);
wherein the pre-trained predictive pharmacokinetic AI model is used for estimating the associated parameter like K1, K2 and TBV to estimate myocardial flow reserve (MFR) map and/or coronary flow reserve (CFR) map.

Each embodiment disclosed herein is contemplated as being applicable to each of the other disclosed embodiments. Thus, all combinations of the various elements described herein are within the scope of the invention.

This invention will be better understood by reference to the experimental data, which follow, but those skilled in the art will readily appreciate that the specific experiments detailed are only illustrative of the invention as described more fully in the claims, which follow thereafter.

### EXPERIMENTAL METHOD

### Example 1

Rb-82 is administered to patients. 20 subjects/patients (N=20) scans are selected with a wide range of uptake defect severities on Rb-82 stress PET perfusion imaging. The input signal is multi-layer perceptron (MLP), artificial neural network (ANN), convolutional neural network (CNN), recurrent neural network (RNN), long short-term memory recurrent neural network (LSTM-RNN), gated recurrent unit (GRU) network, Generative adversarial networks (GANs), deep machine learning and/or combinations thereof network to simultaneously predict uptake rate (K₁), K₂ and total blood volume (TBV) and the 3D parametric images of K₁, K₂ and TBV are combined to estimate the MBF and/or MFR.

### Example 2

Rb-82 is administered to 40 patients (N=40) from two scanners (20 from GE Discovery 690, 20 from GE Discovery 600) were identified from Cardiac PET studies from 2019 covering a wide range of defect severities on 82Rb stress PET. Data from the Discovery 690 was split into training/validation/test sets with a 60:20:20 split. All Discovery 600 data constituted a separate hold-out test set. Image-derived arterial blood input functions (AIF) and voxel time series/time activity curves (TACs) in a 196×196×98 mm³ region around the heart were used for this study. Kinetic modeling is performed with one tissue compartment model (1TCM) with the classical nonlinear least squares (NLS) method to produce reference parametric maps. AIFs and voxel TACs were fed to a Convolutional/Long-Short Term Memory Neural Network (CNN-LSTM) to predict K₁ and TBV and the associated predicted TACs. The AI model was optimized to minimize the mean squared error between the input and predicted TACs (FIG. 3). The results are depicted below:

### Results

The AI model yielded accurate predictions of K₁ and TBV with average R² values of 0.998 and 0.991 for the Discovery 690, and 0.995 and 0.997 for the Discovery 600 hold-out test sets (FIGS. 4-19). Generating parametric maps on a typical central processing unit (CPU) took an average of 89.1 minutes for the classical NLS method and 7.21 seconds with the AI enabled model as described in Example 2, which is 741 times faster.

These two working examples of the present invention for AI models can generate blood flow parametric maps with high accuracy and in a timeframe acceptable for clinical use and thus may enable future clinical implementation.

### Example 3

### Data Preparation

N=1912 patients from two scanners (918 from a GE Discovery 600, 994 from a GE Discovery 690) were identified from Cardiac PET studies from 2019 at the Ottawa Heart Institute covering a wide range of defect severities on ⁸²Rb stress PET. Data from the Discovery 600 was split into 60:20:20 training: validation: test sets. All Discovery 690 data constituted a separate hold-out test set. Image-derived arterial blood input functions (AIF) and voxel time activity curves (TACs) of the left ventricle (LV) myocardium, cavity, and immediate environment were extracted using the FlowQuant software. AIFs and voxel TACs were normalized by the AIF max.

The inventors of the present invention performed kinetic modeling of the 1TCM with the classical nonlinear least squares (NLS) method to produce reference parametric maps.

### Model Training and Evaluation

AIFs and voxel TACs were fed to a Convolutional/Long-Short Term Memory Neural Network to predict K₁ and TBV and the associated theoretical TACS according to the 1TCM. The AI model was optimized to minimize the mean squared error (MSE) between the observed and theoretical TACS (FIG. 1). Finally, the inventors of the present invention computed and compared the average time to compute the parametric maps from a full dynamic 3D acquisition between the AI and classical curve fitting method.

### Results

### Model Training and Performance

The model trained for 40 epochs and achieved the lowest validation MSE loss on the 31^{st}.

Regarding the generation time of parametric maps, AI took an average of 7.21±0.61 seconds vs 89.1±3.2 minutes for classical curve fitting, resulting in an acceleration factor of 741.

The trained model yielded highly accurate predictions of K₁ and TBV and showed no signs of overfitting and excellent generalization to unseen patients and data from a different scanner (Table 1, FIG. 23):

TABLE 1
AI model performance on the mean squared error (MSE)
between the observed and theoretical time activity
curves (TACs), the coefficient of determination (R²) for the
reference and predicted TACs, K₁, and TBV

| | | | Test | Test |
|---|---|---|---|---|
| Metric | Training | Validation | (Discovery 600) | (Discovery 690) |
| MSE | 0.00165 | 0.00138 | 0.00142 | 0.00160 |
| R²TAC | 0.918 | 0.922 | 0.924 | 0.931 |
| R² K₁ | 0.988 | 0.997 | 0.999 | 0.997 |
| R²TBV | 0.993 | 0.995 | 0.999 | 0.998 |

### Example 4

The dataset comprised of N=2790 patients who underwent rest and stress 82Rb Cardiac PET studies on either a GE Discovery 690 or 600 at the Ottawa Heart Institute for suspicion of coronary artery disease during 2018 and 2019. Data from 2018 constituted the training set (N=3568 scans), whereas the validation (N=958) and test sets (N=1054) were from the Discovery 690 and 600 in 2019, respectively. Constructing a Convolutional Long-Short Term Memory (ConvLSTM)-U-Net to take as input reconstructed 4D dynamic PET data and output a 3D probability map for deriving a weighted average AIF by multiplying the probability map to the PET data for each time frame. The proposed AIF along with tissue time activity curves (TACs) of a target organ—here, the LV—were used for kinetic modeling of the 1TCM using a second, previously trained AI model. Unlike classical non-linear least squares regression for kinetic modeling, the second AI model can estimate uptake (K1) and fractional blood volume (FBV) upon inference. The AI-derived K1 and FBV values re-entered the 1TCM in order to generate theoretical TACs and were compared to the observed LV TACs to calculate a mean squared error (MSE) loss function. This end-to-end training architecture allowed for the MSE error to be back-propagated through the ConvLSTM-U-Net for model updating. In this way, the ConvLSTM-U-Net learns to derive an AIF specific to the TACs of a target organ without any a priori anatomical knowledge or human annotation.

### Results

The ConvLSTM-U-Net model successfully converged after 20 epochs, showing great generalization to the validation and test sets (MSEtrain=0.00098, MSEval=0.0011, MSEtest=0.00090) and excellent correlation of predicted vs. observed TACs (R2val=0.92, R2val=0.93). The ConvLSTM-U-Net consistently and specifically generated ROIs at the base of the LV and in the LA, concordant with common physiological assumptions of arterial blood inputs.

The self-supervised AI model of the present invention naturally found that the most optimal ROI placement for deriving an AIF for MBF estimate is at the border of the LV and LA. Further, the robust model, trained and validated on a large sample size of the present invention can increase confidence in downstream MBF estimation through interpretable and consistently generated AIFs. Future works will extend this framework for deriving other organ-specific AIFs, such as for the brain, kidneys, etc., and other pharmacokinetic models.

1. A method for computing an arterial input function from a region of interest, the method comprising:
a) obtaining a plurality of dynamic image data sets comprising volumetric image data from the region of interest over multiple scanning intervals;
b) utilizing an artificial neural network to segment the plurality of dynamic image data sets displaying one or more arterial input function(s) (AIF) in the region(s) of interest;
c) automatically estimating, using artificial intelligence, an arterial input function based on a plurality of dynamic image data sets combined with one or more-time activity curves (TAC) in the region(s) of interest in target organ(s); and
d) computing a pre-trained predictive pharmacokinetic AI model arterial input function using a time activity curve input associated with the region(s) of interest of the target organ(s).

2. The method of claim 1, wherein the artificial neural network in step b) is a self-trained or un-supervised machine learning model.

3. The method of claim 1, wherein the artificial neural network in step b) is selected from the group consisting of multi-layer perceptron (MLP), artificial neural network (ANN), convolutional neural network (CNN) and/or 1D convolutional neural network (1D-CNN), recurrent neural network (RNN), long short-term memory recurrent neural network (LSTM-RNN), gated recurrent unit (GRU) network, generative adversarial networks (GANs), deep machine learning, reinforcement learning algorithm and/or combinations thereof.

4. The method of claim 1, wherein the pre-trained predictive pharmacokinetic AI model in step d) is used to estimate the pharmacokinetic parameters.

5. The method of claim 4, wherein the pharmacokinetic modelling can be selected from the group consisting of one, two, three, or four tissue compartment model.

6. The method of claim 4, wherein the pharmacokinetic AI model can be selected from the group consisting of heart, brain, kidneys, lower extremities and/or combinations thereof.

7. The method of claim 5, wherein the one, two, three, or four tissue compartment model estimates the K1, k2, fractional blood volume, total blood volume and/or combinations thereof.

8. The method of claim 1, wherein the image data is characterized by administering Rb-82, O-15, N-13, Cu-62-PTSM, 99m-Tc-Sestamibi, Tl-201, and/or combinations thereof.

9. The method of claim 1, wherein the image-data is characterized by administering Rb-82 in rest and stress PET perfusion imaging to highlight small regional flow defects.

10. The method of claim 1, wherein the imaging agent or radionuclide is administered by an automated generation and infusion system and/or intravenous administration of radiopharmaceuticals produced by fission, neutron activation, cyclotron and/or generator.

11. The method of claim 1, wherein the automated radioisotope generation and infusion system comprises Rb-82 elution system.

12. The method of claim 1, wherein the pre-trained predictive pharmacokinetic AI model is a self-trained or un-supervised machine learning model.

13. The method of claim 1, wherein the method further comprises using the error of the predicted time activity curves from the observed time activity curves in the region of interest (ROI) for quality assurance.

14. The method of claim 13, wherein the error is mean squared error (MSE) with a threshold value.

15. The method of claim 14, wherein the mean squared error (MSE) is used to determine the reliability of the region of interest (ROI) and derived AIF.

16. The method of claim 1, wherein the method further comprises generating a parametric map using a trained AIF-ROI segmentation.

17. The method of claim 1, wherein the method further comprises generating one or more parametric maps using a trained AIF-ROI segmentation in combination with one or more parametric mapping methods.

18. The method of claim 17, wherein the one or more parametric mapping methods can be selected from the group consisting of nonlinear least squares regression, basis function method, AI-based model for pharmacokinetic modelling or combinations thereof.

19. A method for computing an arterial input function (AIF) from a region of interest (ROI), the method comprising:
a. obtaining a plurality of dynamic image data sets comprising volumetric image data from one or more regions of interest (ROI) over multiple scanning intervals;
b. utilizing an artificial neural network to segment the plurality of dynamic image data sets displaying one or more arterial input function(s) (AIF) in the one or more regions of interest;
c. automatically estimating, using artificial intelligence, an arterial input function (AIF) based on plurality of dynamic image data sets combined with one or more-time activity curves (TAC) in the one or more regions of interest (ROI) in target organ(s); and
d. computing a pre-trained predictive pharmacokinetic AI model arterial input function using time activity curve (TAC) input associated with the one or more regions of interest (ROI) of target organ(s);
wherein the pre-trained predictive pharmacokinetic AI model is used for estimating the associated parameter to determine the parametric map.

20. A method for computing an arterial input function (AIF) from a region of interest (ROI), the method comprising:
a. obtaining a plurality of PET dynamic image data sets comprising volumetric image data from the region of interest (ROI) over multiple scanning intervals;
b. utilizing an artificial neural network to segment the plurality of dynamic image data sets displaying one or more arterial input function(s) (AIF) in the region of interest (ROI);
c. automatically estimating, using artificial intelligence, an arterial input function (AIF) based on plurality of dynamic image data sets combined with one or more-time activity curves (TAC) in the region of interest (ROI) in a target organ; and
d. computing a pre-trained predictive pharmacokinetic AI model arterial input function (AIF) using time activity curve (TAC) input associated with the region of interest (ROI) of the target organ;
wherein the pre-trained predictive pharmacokinetic AI model is used for estimating the associated parameter comprising K1, K2 and TBV to estimate myocardial flow reserve (MFR) map and/or coronary flow reserve (CFR) map.
